(19) United States
(12) Patent Application Publication
(10) Pub. No.: US 2026/0202969 A1
(43) Pub. Date: Jul. 16, 2026

(54) STORAGE ACCELERATION DEVICES FOR DISAGGREGATED STORAGE ACCELERATION

(71) Applicant: MangoBoost, Inc., Bellevue, WA (US)

(72) Inventors: Heetaek JEONG, Bellevue, WA (US); Wonsik LEE, Seoul (KR); Dongup KWON, Seoul (KR); Eriko NURVITADHI, Bellevue, WA (US)

(21) Appl. No.: 19/446,638

(22) Filed: Jan. 12, 2026

Related U.S. Application Data
(60) Provisional application No. 63/744,756, filed on Jan. 13, 2025.

(51) Int. Cl. G06F 3/06

(52) U.S. Cl. CPC G06F 3/0613; G06F 3/0656; G06F 3/0679

(57) ABSTRACT

Techniques for disaggregated storage acceleration are disclosed. A storage acceleration device offloads data plane operations from a host device. The storage acceleration device includes a transport acceleration system and a payload acceleration system. The transport acceleration system offloads, from the host device, transport operations such as encapsulating a payload into a transport message or decapsulating a transport message into a payload. The payload acceleration device offloads payload operations from the host device. The payload operations may include translating the payload from a fabric storage format to a local storage format. By offloading data plane operations from the host device, the storage acceleration device frees computing resources of the host device.

### CROSS-REFERENCE TO RELATED APPLICATIONS

This application claims priority to U.S. Provisional Application No. 63/744,756, entitled “NEXT-GENERATION STORAGE SYSTEM USING DATA PROCESSING UNIT SOLUTIONS”, and filed on Jan. 13, 2025, and is related to Korean Application No. 10-2024-0114812, entitled “HARDWARE-BASED ACCELERATION APPARATUS FOR NVME OVER FABRICS TARGET, OPERATION METHOD THEREOF, AND SYSTEM INCLUDING THE SAME”, filed on Aug. 27, 2024, both of which are hereby incorporated by reference in their entirety. In cases where the present application conflicts with an incorporated reference, the present application controls.

### TECHNICAL FIELD

The present disclosure relates to storage acceleration, and more particularly, to disaggregated storage acceleration.

### BACKGROUND

In modern datacenters, data transfer capacity continues to rise. Today, PCI Express (PCIe), which is a common interconnect between a central processing unit (CPU) and I/O peripherals, delivers a bidirectional bandwidth of 128 GB/s with the widely adopted 16-lane Gen 5.0. The bandwidth doubles in Gen 6.0 and doubles again in Gen 7.0, reaching 512 GB/s. Accordingly, the performance of network interface cards (NICs) is also increasing, with 400 GbE for PCIe Gen 5.0 and 800 GbE for PCIe Gen 6.0. However, challenges remain in achieving these theoretical performance levels in implementation. A substantial number of CPU cores are required to achieve the target bandwidth in a disaggregated storage system running non-volatile memory express over fabric (NVMe-oF). Even with four PCIe Gen 5.0 NICs and two 192-core CPU sockets, nearly 300 CPU cores are utilized to achieve an aggregate bandwidth of 1.6 Tbps. Because the number of CPU cores typically doubles with each doubling of memory bandwidth, modern storage systems face exponentially escalating CPU overhead to support improved storage technologies. This is commonly referred to as the “storage tax.”

### BRIEF SUMMARY

Storage acceleration devices for providing disaggregated storage acceleration are described.

In some embodiments, an initiator device is in communication with a host device such as a server. The initiator device presents standard interfaces (e.g., NVMe, VirtIO-blk) to the host device and accelerates the I/O path by decoupling the data plane from the control plane. The initiator device translates user protocols into transport protocols (e.g., PCIe, TCP, and RDMA). To prevent data starvation in multi-tenant environments, the initiator device dynamically schedules I/O requests to avoid interrupting other tenants, ensuring expected performance for each tenant. The initiator device also offloads and accelerates transport operations, reducing host device resource usage.

The initiator device emulates a local storage device of the host device, but provides access to disaggregated storage resources that may be remote from the host device.

From the perspective of the host device, the initiator device is a local storage device with addressable memory (e.g., an NVMe SSD). Accordingly, when the host device requests data accessible to the initiator device, it may provide the data request to the initiator device in a local storage format according to a local storage protocol such as NVMe, serially attached SCSI (SAS), serial ATA (SATA), or compute express link (CXL).

The initiator device obtains the data request from the host device and processes the data request into a payload using a payload acceleration system. The payload is used to request the data from a disaggregated storage resource that stores the data. Converting the data request into the payload may include converting the data request from the local storage format to a fabric storage format such as NVMe-oF.

The initiator device uses a transport acceleration system to package and send the payload to a target device that stores the requested data. In some embodiments, the transport acceleration system packages the payload into a transport message such as a TCP packet.

The target device processes the transport message and provides a second transport message that includes the requested data to the initiator device.

The initiator device receives the second transport message and extracts the requested data from the second transport message. The initiator device provides the requested data to the host device in response to the data request.

By offloading the steps of preparing and sending the data request to a disaggregated storage resource from the host device, the initiator device significantly reduces dedication of processing resources by the host device for performing disaggregated storage operations. This frees computing resources of the host device to perform other operations. The initiator device also enables high-bandwidth disaggregated storage operations to be performed by host devices that would otherwise be unable to support these operations due to processing resource constraints.

In some embodiments, the target device is a storage acceleration device that operates similarly to the initiator device (i.e., a target device). In these embodiments, the target device offloads disaggregated storage operations from a remote host device that stores the requested data.

Because the initiator device typically provides the transport message to the disaggregated storage resource using standardized formats (e.g., as a TCP packet that encapsulates an NVMe-oF request), the disaggregated storage resource is not necessarily a storage acceleration device similar to the initiator device. In some embodiments, the disaggregated storage resource is a computing device such as a server that receives and processes the transport message using a general-purpose processor. This enables the initiator device to access data stored by servers that do not necessarily have a target device installed.

In some embodiments, the initiator device processes control plane requests for emulated devices exposed to the host device using an embedded CPU separate from a processor used to perform data plane operations. For example, the initiator device may use the embedded CPU to set up network connections, establish NVMe-oF sessions, or perform other control plane operations.

In various embodiments, the target device operates similarly to the initiator device, and includes a transport acceleration system and a payload acceleration system. The target device receives a first transport message from the initiator device and extracts a local storage command from the first transport message. The target device provides the local storage command to a local storage device and receives requested data in response. The target device processes the requested data into a second transport message and provides the second transport message to the initiator device. In this way, the target device offloads operations associated with processing transport messages and accessing storage resources from its host device.

Because the target device typically provides the second transport message to the initiator device using standardized formats (e.g., as a TCP packet that encapsulates an NVMe-oF request), the initiator device is not necessarily a storage acceleration device similar to the target device. In some embodiments, the initiator device is a computing device such as a server that receives and processes the second transport message using a general-purpose processor.

In some embodiments, the target device processes transport packets received over the network entirely in hardware. After translating transport packets into NVMe commands, the target device can further process the data based on user requirements utilizing a configurable region. For example, the configurable region may apply RAID, compression, or encryption to the data. The target device provides NVMe commands with the processed data to the NVMe SSDs.

In some embodiments, the target device enables data sharing among tenants by allowing simultaneous access to the same SSDs.

In some embodiments, the target device functions as a root complex when the host device is a “just a bunch of flash” (JBoF) device without host resources.

In some embodiments, the target device includes a command scheduler that manages quality of service for various users.

### BRIEF DESCRIPTION OF THE SEVERAL VIEWS OF THE DRAWINGS

Embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 is a system diagram illustrating a transport acceleration system and a payload acceleration system of a disaggregated storage acceleration device in some embodiments.

FIG. 2 is a context diagram of an environment that provides disaggregated storage acceleration in some embodiments.

FIG. 3 is a system diagram illustrating an initiator device for disaggregated storage acceleration in some embodiments.

FIG. 4 is a system diagram illustrating a target device for disaggregated storage acceleration in some embodiments.

FIG. 5 is a logical flow diagram illustrating an example process performed by an initiator device to provide disaggregated storage acceleration in some embodiments.

FIG. 6 is a logical flow diagram illustrating an example process performed by a target device to provide disaggregated storage acceleration in some embodiments.

FIG. 7 is a system diagram illustrating interaction between a storage acceleration device and a host device in some embodiments.

FIG. 8 is a system diagram illustrating interaction between a storage acceleration device and a host device in some embodiments.

FIG. 9 illustrates an example command message in some embodiments.

FIG. 10 is a system diagram illustrating components of a payload acceleration system of a storage acceleration device in some embodiments.

FIGS. 11a-11g are context diagrams illustrating operation of a payload acceleration system processing payloads associated with two sessions in some embodiments

FIG. 12a-12c are system diagrams illustrating example configurations of transport acceleration systems and data plane acceleration systems of a storage acceleration device in some embodiments.

### DETAILED DESCRIPTION

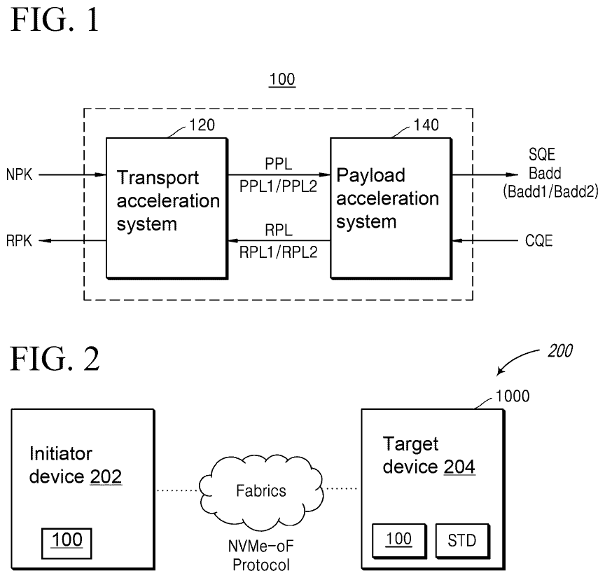

FIG. 1 is a system diagram illustrating a transport acceleration system and a payload acceleration system of a disaggregated storage acceleration device (i.e., acceleration device or storage acceleration device) in some embodiments.

Acceleration device 100 offloads disaggregated storage operations from a host device. In various embodiments, acceleration device 100 is included in an initiator device (e.g., a device that requests a disaggregated storage operation) or a target device (e.g., a device that performs a disaggregated storage operation). The host device is a computing device such as a server. The server may be a just a bunch of flash (JBoF) server. In some embodiments, acceleration device 100 communicates with the host device using PCIe. For example, acceleration device 100 may be implemented as a PCIe device in communication with a PCIe interface of the host device.

Acceleration device 100 includes transport acceleration system 120 and payload acceleration system 140. Transport acceleration system 120 performs operations to accelerate processing of transport messages (i.e., packets) between acceleration device 100 and disaggregated storage resources such as remote servers or local storage devices. A transport message is formatted according to a transport protocol such as TCP, UDP, remote direct memory access (RDMA) over converged ethernet (RoCE), or any other transport protocol. In some embodiments, the transport message includes a header and a payload.

Transport acceleration system 120 receives a transport message “NPK” from a disaggregated storage resource and converts the transport message into a payload “PPL” that is provided to payload acceleration system 140.

In some embodiments, the payload includes a network identifier that identifies a network session of the transport message. In some embodiments, the payload includes metadata. In some embodiments, converting the transport message into the payload includes removing a header from a packet of the transport message.

In some embodiments, transport acceleration system 120 receives a second payload “RPL” from payload acceleration system 140, and converts the second payload into a second transport message “RPK”. In this way, transport acceleration system 120 offloads transport operations associated with disaggregated storage from a host device.

In some embodiments, transport acceleration system 120 performs various transport operations such as error detection, retransmission, queue management, etc.

Payload acceleration system 140 performs operations to accelerate processing of payloads. In some embodiments, payload acceleration system 140 receives a first payload “PPL” from transport acceleration system 120. Based on PPL, payload acceleration system 140 provides an SQE to a buffer. The buffer is read by a storage device, which performs an operation indicated by the SQE, such as a read or write operation. Payload acceleration system 140 receives a completion queue entry (CQE) from the storage device, indicating a completion status of the operation. In some embodiments where the operation is a read operation, the CQE includes data requested in the read operation. The CQE may contain metadata or other information associated with the operation. Based on the CQE, payload acceleration system 140 produces a second payload “RPL”, which it provides to transport acceleration system 120.

In some embodiments, payload acceleration system 140 converts a fabric storage operation such as an NVMe-oF operation into a local storage operation such as an NVMe operation usable by the storage device. In various embodiments, the payload includes a command, data, or both.

In some embodiments, the transport acceleration system bypasses payload acceleration system 140, providing PPL to the host device for processing. This enables processing of payloads that may not be supported by payload acceleration system 140. In one example, PPL is in SATA format, which payload acceleration system 140 may not be configured to process. Accordingly, PPL is provided to a processor of the host device for processing.

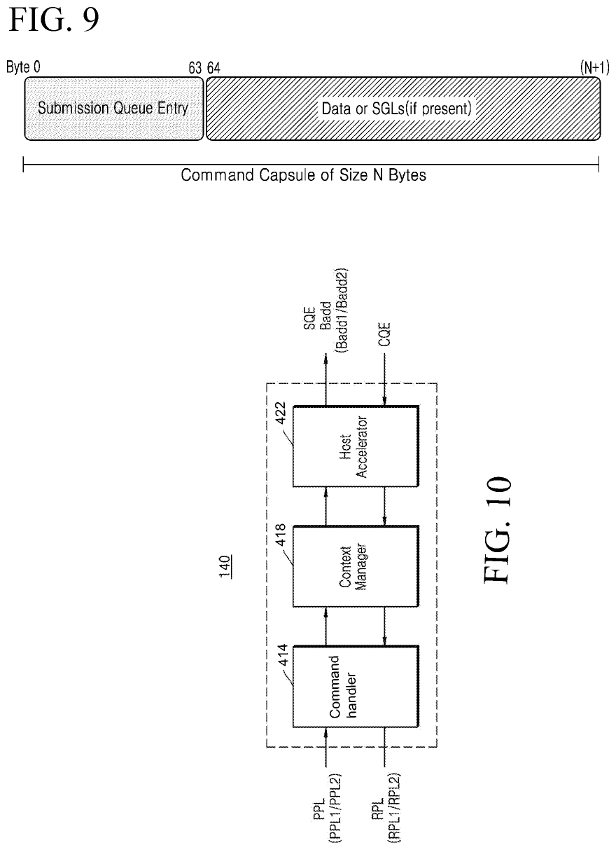

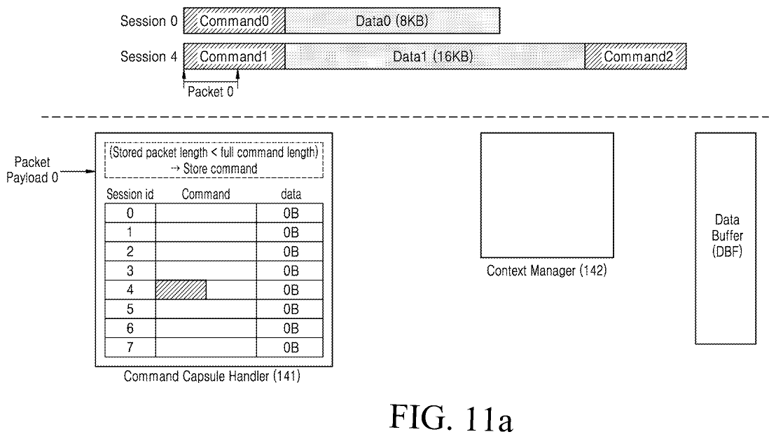

FIG. 9 illustrates an example N-byte payload that includes a 64-byte command “Submission Queue Entry” (SQE) and data associated with the command. For I/O commands, the SQE is an opcode that indicates a type of the command. In one example, an SQE indicates a write operation using opcode “01h”. In another example, an SQE indicates a read operation using opcode “02h”. In some embodiments, the payload includes a finite-value command identifier, a namespace to which to apply the command, a message metadata pointer, a physical pointer indicating a physical address of data, or other pointers used to implement the command.

FIG. 10 is a system diagram illustrating components of a payload acceleration system of a storage acceleration device in some embodiments. Payload acceleration system 140 includes command handler 414, context manager 418, and host accelerator 422. In various embodiments, payload acceleration system 140 is included in an initiator device or a target device.

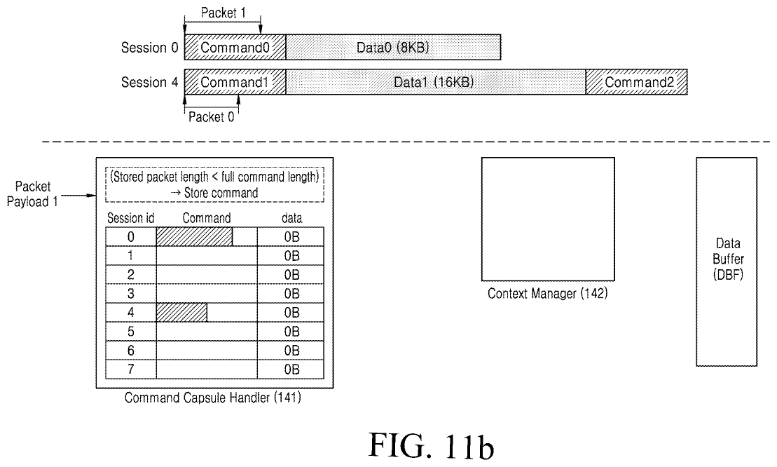

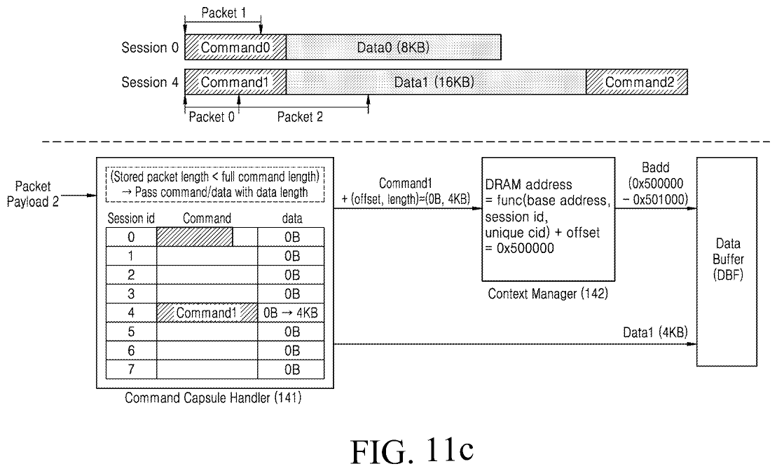

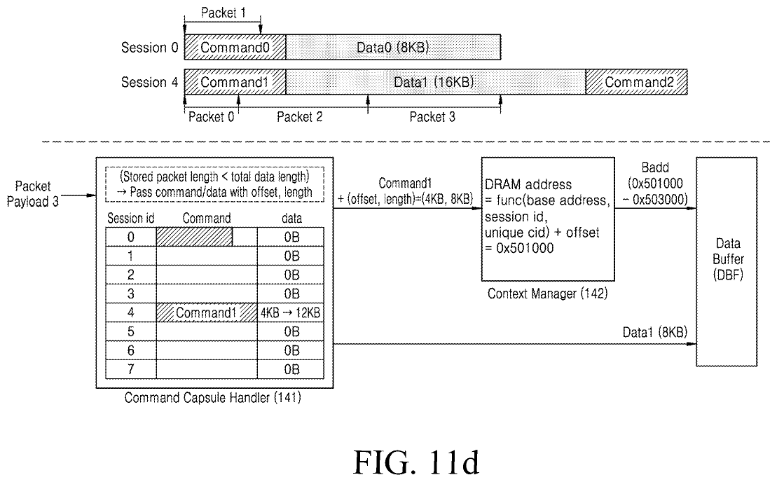

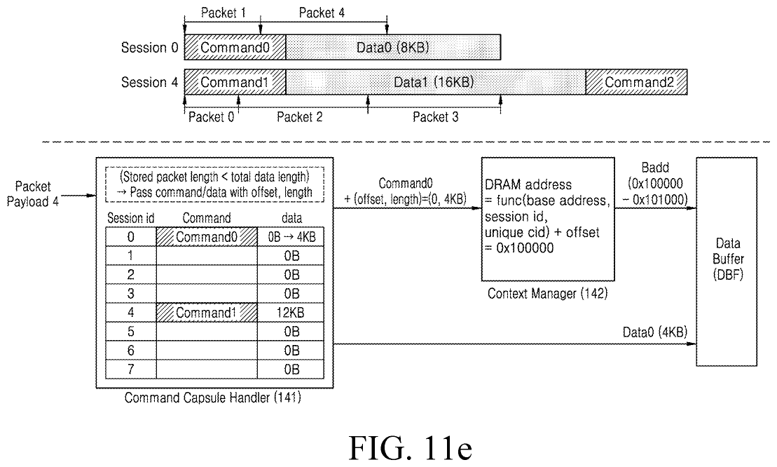

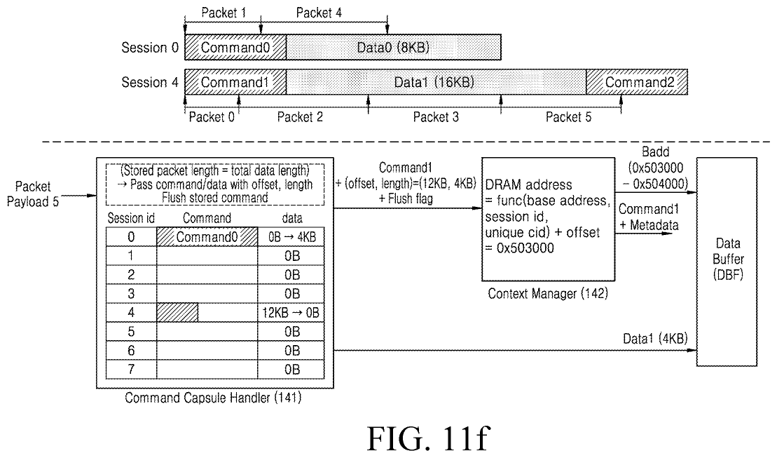

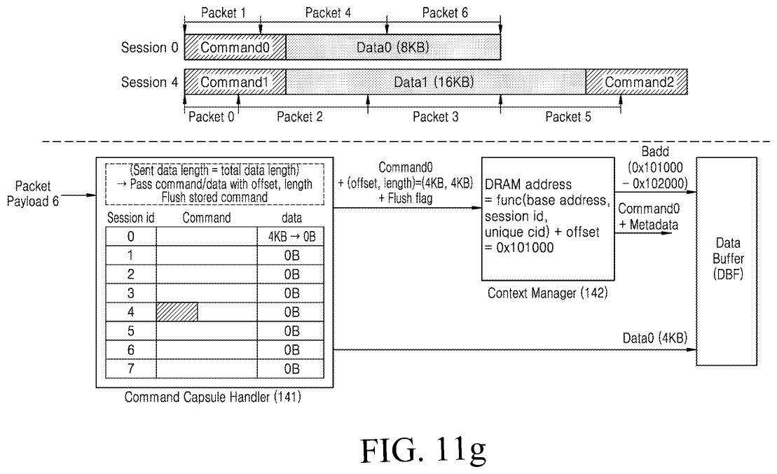

Command handler 414 stores command data of payloads. In some embodiments, command handler stores the command data in a handling table as shown in FIGS. 11a-11g. In various embodiments, command handler 414 stores additional information associated with the command data, such as an indication of a size of data received for a command. Command handler 414 receives a payload and associates command data of the payload with a network session from which the payload was received. In one example where the payload was included in a transport message provided in network session 0, command handler 414 stores the command data in a field corresponding to session 0. In cases where portions of a command are split across two or more payloads, command handler accumulates the command from the two or more payloads such that the complete command can be reconstructed.

As discussed herein, the payload may include a command identifier that identifies a command to be performed. In one example where the command is divided between multiple payloads, each of the multiple payloads include a same command identifier indicating that they constitute the same command. Command handler 414 provides command data of the payload to context manager 418, which determines a buffer address at which to store information associated with the payload. Command handler 414 may provide other information such as a buffer offset and a size of data associated with a command to be stored in a buffer.

Context manager 418 assigns a unique buffer address to the payload based on identification information of the payload. Context manager 418 receives command data from command handler 414 and determines the identification information based on the command data. The identification information may include a command identifier, a metadata, a network identifier, etc., or any combination thereof. In some embodiments, context manager 418 receives additional information from command handler 414, such as an offset and length of data associated with the command.

Host accelerator 422 buffers a submission queue entry (SQE) to an area of a data buffer corresponding to the buffer address determined using context manager 418. Host accelerator 422 receives a completion queue entry (CQE) from a device that accesses the data buffer. The CQE may include a completion status of a storage operation requested in SQE provided by a storage device that performs the operation.

Operation of command handler 414, context manager 418, and host accelerator 422 is described in further detail at least with respect to FIGS. 11a-11g.

FIG. 2 is a context diagram of an environment 200 that provides disaggregated storage acceleration in some embodiments. Environment 200 includes initiator device 202 and target device 204, which communicate using a fabric protocol such as NVMe-oF. As discussed herein, the initiator device requests disaggregated storage operations to be performed by the target device.

Initiator device 202 provides a first transport message including an operation to be performed by a storage device “STD” associated with target device 204. Target device 204 processes the first transport message into a local storage command usable by storage device “STD” to perform the operation requested by initiator device 202. Target device 204 processes the data into a second transport message and provides the second transport message to initiator device 202. In response to receiving the second transport message, initiator device 202 extracts the requested data from the second transport message.

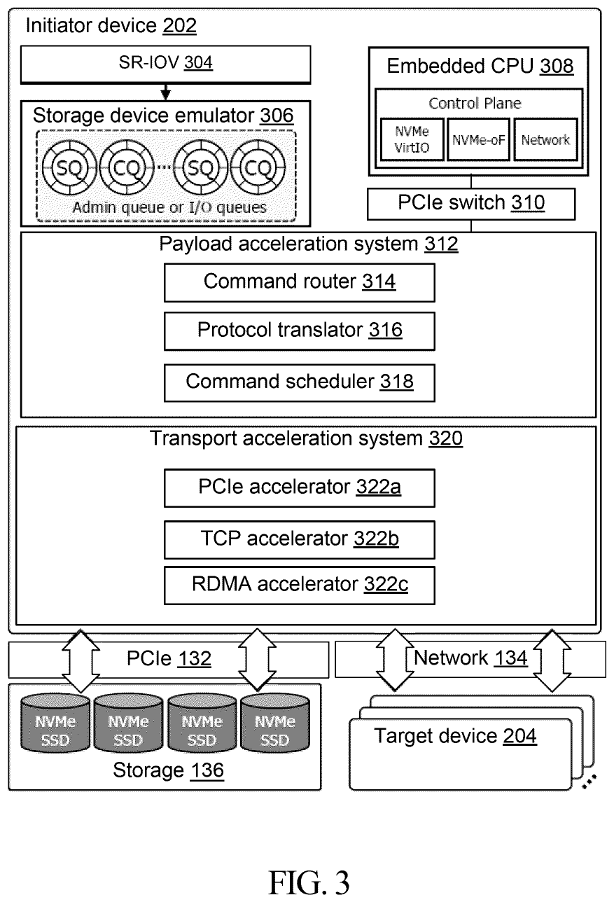

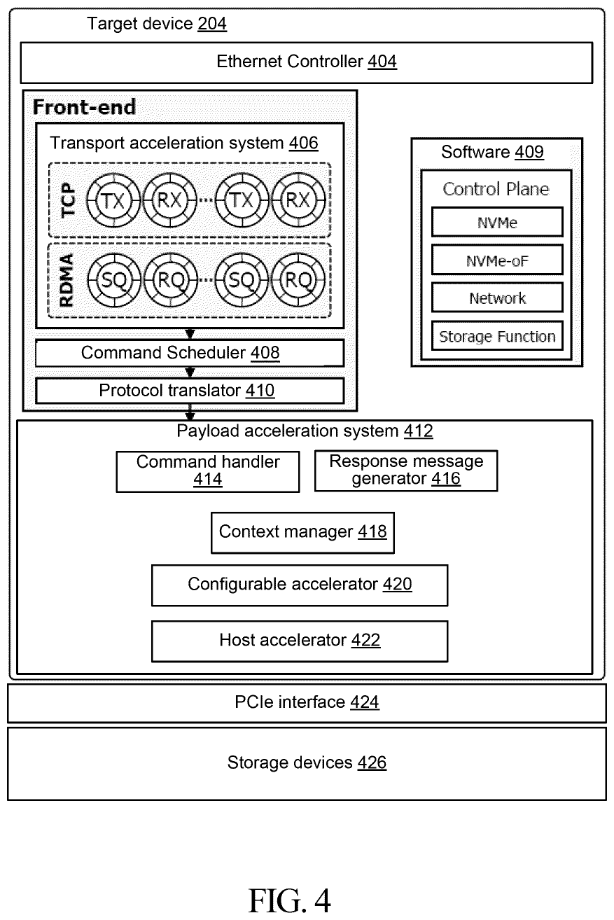

While initiator device 202 and target device 204 are shown as including a same storage accelerator 100, initiator device 202 and target device 204 typically include different embodiments of storage accelerator 100, as discussed with respect to FIGS. 3 and 4. Because typical workflows of initiator device 202 and target device 204 vary, configuration or implementation details of the storage accelerators may vary between the initiator device and the target device. In one example, the initiator device implements a payload acceleration system as a frontend and a transport acceleration system as a backend because the initiator device first creates a payload based on an operation request from a host device, and then processes the payload into a transport message using the transport acceleration system. Similarly, because the target device first receives a transport message and then processes the transport message into a local storage command, the target device may implement a transport acceleration system as a frontend and a payload acceleration system as a backend.

Additionally, while initiator device 202 and target device 204 are discussed herein as different devices for ease of discussion, in various embodiments, initiator device 202 functions as a target device or target device 204 functions as an initiator device. In other words, functions of initiator device 202 and target device 204 may be implemented by a same storage acceleration device, enabling the storage device to act as both a target device and an initiator device.

FIG. 3 is a system diagram illustrating an initiator device for disaggregated storage acceleration in some embodiments.

Initiator device 202 includes single root I/O virtualization system (SR-IOV) 304, storage device emulator 306, embedded CPU 308, PCIe switch 310, payload acceleration system 312, and transport acceleration system 320. In various embodiments, any combination of one or more components of initiator device 202 are implemented using a special-purpose processor such as a field-programmable gate array (FPGA) or application-specific integrated circuit (ASIC). In one example, payload acceleration system 312 and transport acceleration system 320 are implemented using a same FPGA.

SR-IOV 304 enables multiple storage devices to be presented as a single storage device.

Storage device emulator 306 emulates local storage interfaces for the host device. For example, storage device emulator 306 may emulate standard NVMe/PCIe or VirtIO-blk interfaces for the host device, regardless of the underlying storage type. Adhering to standard protocols allows the initiator device to operate without requiring modifications to existing user applications. In some embodiments, storage device emulator 306 implements an administrative queue or an I/O queue to enable emulation of local storage interfaces.

In some embodiments, storage device emulator 306 complies with the NVMe standards, providing interfaces used by NVMe device. The interfaces include submission/completion queues, queue doorbells, and controller capability registers, etc. Compliance with standardized local storage protocols enables the initiator device to support various environments such as Linux, Windows, VMware ESXi, or UEFI.

Embedded CPU 308 is a general-purpose processor used to perform various dynamic operations such as control plane operations. In some embodiments, embedded CPU 308 is connected via embedded PCIe switch 310.

Data plane operations (e.g., read and write) are compute-demanding, performance-critical, and typically follow consistent processing flows. For example, packaging payloads into transport messages is typically repetitive and can be performed using a special-purpose processor such as transport acceleration system 320. The consistency of data plane operations enables acceleration using payload acceleration system 312 and transport acceleration system 320.

In contrast, control plane operations (e.g., network connection setup) typically involve distinct processing flows different from those of data plane operations. Accordingly, in some embodiments control plane operations are processed on embedded CPU 308. Initiator device 202 determines which plane each payload belongs to (e.g., control plane or data plane) and routes it to the appropriate processing unit.

In some embodiments, embedded CPU 308 is configurable to perform various operations with respect to the transport acceleration system and the payload acceleration system. For example, embedded CPU 308 may be configured to perform various application-specific operations with respect to payloads being processed by the transport acceleration system and the payload acceleration system. In some embodiments, embedded CPU 308 obtains a payload from payload acceleration system 312 and performs a series of one or more operations with respect to the payload before providing the payload to transport acceleration system 320. By switching data between embedded CPU 308 and other components such as payload acceleration system 312 and transport acceleration system 320, embedded CPU 308 enables highly flexible processing to be performed on initiator device 202 without necessarily using computing resources of the host device.

In various examples, embedded CPU 308 is configured to apply an operation such as compression, data de-duplication, data filtering, etc. In various embodiments, embedded CPU 308 is used to apply any operation to data at any stage of processing by initiator device 202. In some embodiments, embedded CPU 308 is user-configurable to perform an operation specified by a user.

While embedded CPU 308 is shown as implementing control plane operations, in various embodiments, at least some control plane operations are performed using the host device. For example, the host device may be used to establish or maintain network connections between initiator device 202 and target device 204.

Payload acceleration system 312 processes payloads such as NVMe data requests received from the host device. Payload acceleration system 312 includes command router 314, protocol translator 316, and command scheduler 318. In various embodiments, payload acceleration system 312 implements functionality of payload acceleration system 140 of FIG. 10.

Command router 314 determines which plane a payload belongs to, for example, the data plane or the control plane, and routes the payload based on the plane. In some embodiments, command router 314 routes data plane operations to protocol translator 316 or command scheduler 318. In some embodiments, command router 314 routes control plane payloads to embedded CPU 308 or the host device to be processed.

Protocol translator 316 translates protocols of received payloads from a first protocol to a second protocol. While emulating NVMe (or VirtIO-blk) devices on the front-end using storage device emulator 306, initiator device 202 communicates with various types of storage systems on the back-end. In various examples, these storage systems include collections of local SSDs, remote storage servers connected via NVMe-oF, storage clusters based on Ceph, etc. To accommodate the various underlying transports and protocols used by these systems, protocol translator 316 translates from a local storage protocol used by storage device emulator 306 to a protocol used by a back-end storage system. In one example where initiator device 202 communicates with an NVMe-oF storage server using NVMe/TCP protocol, protocol translator 316 translates NVMe commands received via storage device emulator 306 into NVMe/TCP Protocol Data Units (PDUs) and further into TCP/IP packets. In another example where initiator device 202 communicates with local PCIe storage using PCIe transport, the command format remains unchanged (i.e., NVMe/PCIe command). In some such examples, certain fields within the command are modified based on how the original storage is virtualized. For example, a single SSD may be virtualized into multiple SSDs. Protocol translator 316 enables initiator device 202 to provide a unified and transparent storage interface to the host device, regardless of the underlying storage system.

Command scheduler 318 schedules commands received from users to meet Quality of Service (QoS) requirements across various scenarios. Command scheduler 318 attributes received commands to particular users such that the commands can be scheduled according to scheduling policy. In some embodiments, the scheduling policy is flexibly configured to meet varying performance requirements, which may depend on the workload characteristics. In one example, a higher priority is set for a select user to maximize aggregate bandwidth for the select user. In another example, bandwidth is evenly distributed across users. In another example, bandwidth is dynamically distributed according to any characteristic of a user or workload of the user such as average bandwidth consumption, peak bandwidth consumption, account type, etc. In another example, command scheduler 318 dynamically schedules bandwidth for users to ensure that performance for each user achieves a performance threshold, such as a threshold bandwidth or response latency.

Transport acceleration system 320 accelerates communication with underlying storage devices, using transport accelerators to forward commands from the host interface to the underlying storage. Transport acceleration system includes PCIe accelerator 322a, TCP accelerator 322b, and RDMA accelerator 322c (collectively, transport accelerators 322).

Transport acceleration system 320 selects the appropriate transport accelerator to process a payload. In one example where the payload is destined for NVMe/TCP or NVMe/RDMA-backed storage, transport acceleration system 320 selects TCP accelerator 322b or RDMA accelerator 322c, respectively. The transport accelerators 322 achieve zero-copy from the application, enabling line-rate performance and low latency to access remote storage devices.

In another example where the payload is destined for a local PCIe SSD of storage 136, transport acceleration system 320 selects PCIe accelerator 322a, which allows direct control of local SSDs and PCIe peer-to-peer (P2P) data transfer without requiring host intervention.

Transport acceleration system 320 communicates with storage 136 using PCIe 132 and communicates with target device 204 using network 134.

While transport acceleration system 320 is shown as including PCIe accelerator 322a, TCP accelerator 322b, and RDMA accelerator 322c, in various embodiments transport acceleration system includes any number or combination of accelerators. In some embodiments, transport acceleration system 320 includes multiple instances of a same accelerator. For example, where 90% of communications by transport acceleration system 320 use or are expected to use PCIe accelerator 322a, transport acceleration system 320 may include multiple instances of PCIe accelerator 322a to facilitate greater communication bandwidth with PCIe devices.

FIG. 4 is a system diagram illustrating a target device 204 for disaggregated storage acceleration in some embodiments. Similar to initiator device 202, target device 204 accelerates the data plane through hardware. In some embodiments, the control plane is managed by software 409, which is implemented using the host device in some embodiments. In some embodiments, target device 204 determines whether a host device CPU or an embedded CPU handles the control plane. In one example where target device 204 operates as a PCIe root complex of a JBoF server, the embedded CPU manages the control plane. In some embodiments, the control plane on the target device side is responsible for initializing storage devices to enable PCIe peer-to-peer (P2P) communications.

Target device 204 includes ethernet controller 404, transport acceleration system 406, command scheduler 408, software 409, protocol translator 410, and payload acceleration system 412. Target device 204 communicates with storage devices 426 using PCIe interface 424. In various embodiments, any combination of one or more components of target device 204 are implemented using a special-purpose processor such as a field-programmable gate array (FPGA) or application-specific integrated circuit (ASIC). In one example, payload acceleration system 412 and transport acceleration system 406 are implemented using a same FPGA.

Transport acceleration system 406 accelerates communication with devices requesting data from target device 204, such as initiator device 202. Transport acceleration system 406 includes a TCP accelerator and RDMA accelerator (collectively, transport accelerators). Transport acceleration system 406 selects a transport accelerator of the transport accelerators based on a type of transport message received via ethernet controller 404. In one example where the transport message is a TCP packet, transport acceleration system 406 selects the TCP accelerator to process the transport message, and provides the transport message to the TCP accelerator.

The transport accelerators process transport messages into payloads. Processing a transport message into a payload may include stripping a header such as a TCP header or other transport-related data from the transport message.

In some embodiments, transport acceleration system 406 performs other transport-related operations, such as error detection, retransmission, queue management, etc.

In some embodiments, relative to transport accelerators 320 of initiator device 202, the transport accelerators do not include a PCIe accelerator because data requests of the target device are typically received as transport messages over a network. In various embodiments, target device 204 places the transport acceleration system on the front-end. This design offers the flexibility to either offload payload operations to payload acceleration system 412 or only transport operations to transport acceleration system 406. In some embodiments where target device 204 offloads transport operations but not payload operations, target device 204 is used as a transport layer offloaded NIC, enabling access to storage devices that may not use supported storage protocols. In one example where payload acceleration system 412 supports NVMe protocol, non-NVMe storage devices such as HDDs and SATA SSDs can be supported by accelerating transport operations using transport acceleration system 406, and providing payloads extracted using transport acceleration system 406 to a host computing device of target device 204 to be used to access an HDD or SATA SSD. The host device then provides a payload including the requested data to transport acceleration system 406, which creates a second transport message and provides it to the initiator device.

Command scheduler 408 schedules commands of payloads provided by transport acceleration system 412. In various embodiments, command scheduler 408 is similar to command scheduler 318 of initiator device 202.

Software 409 manages control plane operations of target device 204. At target device 204, control plane requests may include initializing storage devices 426 to enable PCIe P2P communication between target device 204 and storage devices 426. In some embodiments, software 409 is implemented using a CPU of the host device. In some embodiments, software 409 is implemented using an embedded CPU of target device 204 (not shown in FIG. 4). In some embodiments, the embedded CPU is similar to embedded CPU 308 of initiator device 202.

Protocol translator 410 translates protocols of received payloads from a first protocol to a second protocol. Typically, protocol translator 410 translates the payload from fabric storage format to a local storage format usable to communicate with a corresponding storage device of storage devices 426. In various embodiments, protocol translator 410 operates similarly to protocol translator 316 of initiator device 204. Because SSDs adhere to the NVMe specification, it may be unnecessary for protocol translator 410 to support translation of the VirtIO-blk protocol. During the translation, protocol translator 410 can dynamically set a destination address for data to be located in various sites, while the data resides in the host memory for the initiator device. When data are forwarded from the network to the NVMe SSDs, NVMe commands and their corresponding data reside in memory with assigned physical addresses, allowing NVMe SSDs to directly access the data through PCIe P2P communication.

Payload acceleration system 412 processes payloads such as NVMe data requests received from the initiator device. In various embodiments, payload acceleration system 412 operates similarly to payload acceleration system 312 of initiator device 202.

Payload acceleration system 412 includes command handler 414, response message generator 416, context manager 418, configurable accelerator 420, and host accelerator 422. In various embodiments, payload acceleration system 412 is implemented based on payload acceleration 140. Accordingly, command handler 414 may correspond to command handler 414, context manager 418 may correspond to context manager 418, and host accelerator 422 may correspond to host accelerator 422.

In various embodiments, command handler 414, response message generator 416, and context manager 418 are similar to command handler 414, context manager 418, and host accelerator 422 described in FIG. 10.

Configurable accelerator 420 processes local storage commands stored in memory of target device 204 or the host device produced using protocol translator 410 to support various storage functions. In various examples, configurable accelerator 420 processes the local storage commands to support RAID, compression, decompression, encryption, decryption, etc. In some embodiments, configurable accelerator 420 is pre-configured with functions to be applied to the local storage functions. In some embodiments, the local storage commands are routed through configurable accelerator 420 for processing before being stored at a buffer address determined using context manager 418.

In various embodiments, target device 204 communicates directly with storage devices 426 over PCIe P2P using PCIe interface 424, enabling it to manage storage devices 426 without involving a CPU of the host device. This enables multiple users or initiator devices to share the same storage devices 426 by assigning different I/O queues to each user or initiator device. In one example, I/O queues 0-15 are assigned to a first user and I/O queues 16-31 are assigned to a second user. Isolation in queue assignment makes it indistinguishable to users that they are sharing the same storage devices 426. Assigning I/O queues can be advantageous, for example, in large-scale AI training systems where multiple GPU nodes access a shared dataset stored using storage devices 426.

In some embodiments, target device 204 acts as a PCIe root complex for storage devices 426 in a JBoF architecture.

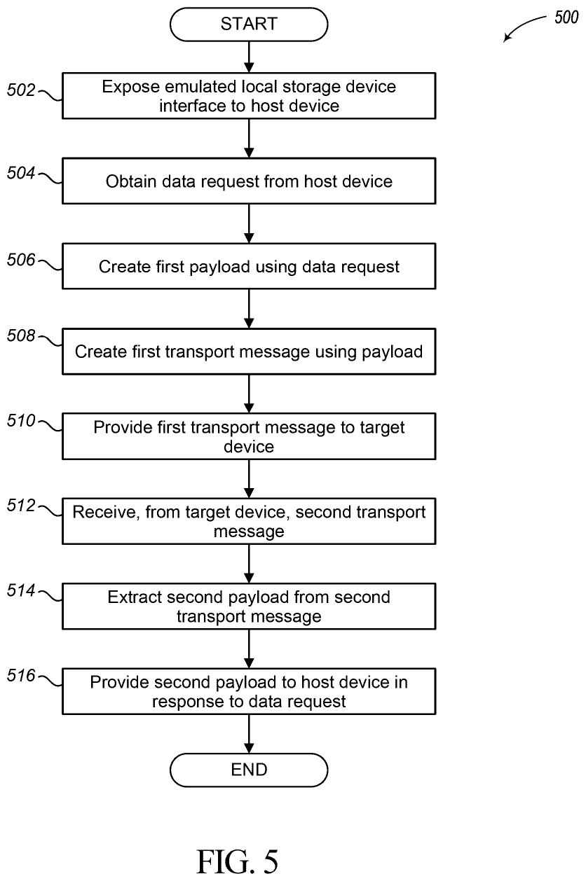

FIG. 5 is a logical flow diagram illustrating an example process 500 performed by an initiator device to provide disaggregated storage acceleration in some embodiments. In various embodiments, process 500 is implemented using initiator device 202 of FIG. 2.

Process 500 begins at block 502, where an emulated local storage device interface is exposed to a host device. In some embodiments, the emulated local storage device interface is exposed using storage device emulator 306 of FIG. 3. After block 502, process 500 continues to block 504.

At block 504, a data request is obtained from the host device. In some embodiments, the data request is obtained via SR-IOV 304 of FIG. 3. After block 504, process 500 continues to block 506.

At block 506, a first payload is created using the data request. In some embodiments, the first payload is created using payload acceleration system 312 of FIG. 3. In some embodiments, creating the first payload includes translating the data request from a first format to a second format, such as from NVMe to NVMe-oF. After block 506, process 500 continues to block 508.

At block 508, a first transport message is created based on the first payload. In some embodiments, creating the first transport message is performed using transport acceleration system 320 of FIG. 3. In some embodiments, creating the first transport message includes encapsulating the first payload into a TCP packet or other transport message. After block 508, process 500 continues to block 510.

At block 510, the first transport message is provided to a target device. The target device may be a storage acceleration device similar to the initiator device or another computing device such as a server. In some embodiments, the first transport message is provided to the disaggregated storage resource according to a command schedule. After block 510, process 500 continues to block 512.

At block 512, a second transport message is received from the target device. In some embodiments, the second transport message is received by transport acceleration system 320 via network 134. After block 512, process 500 continues to block 514.

At block 514, a second payload is extracted from the second transport message. In some embodiments, the second payload is extracted from the second transport message using transport acceleration system 320. After block 514, process 500 continues to block 516.

At block 516, the second payload is provided to the host device in response to the data request via storage device emulator 306 and SR-IOV 304. In some embodiments, payload acceleration system 312 processes the second payload before the second payload is provided to the host device. In one example, payload acceleration system converts the second payload from a first format to a second format before it is provided to the host device. After block 516, process 500 ends.

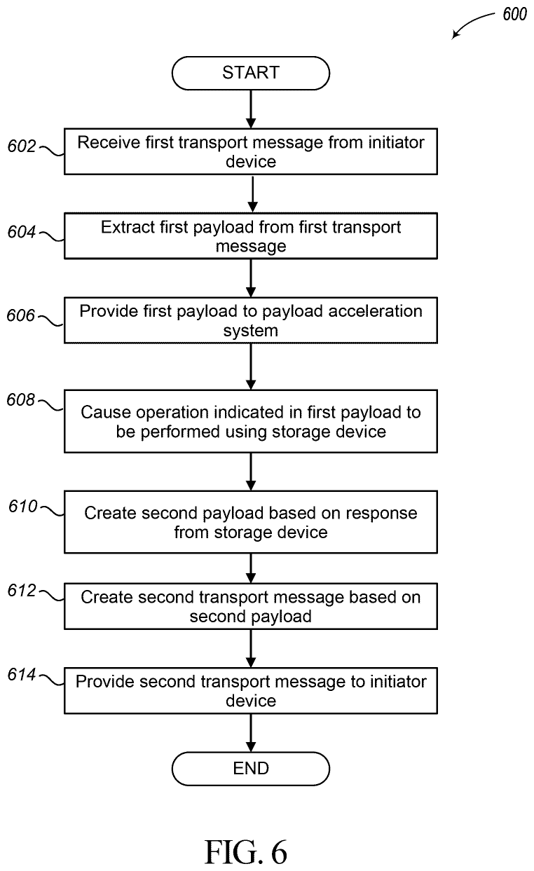

FIG. 6 is a logical flow diagram illustrating an example process performed by a target device to provide disaggregated storage acceleration in some embodiments. In some embodiments, process 600 is implemented using target device 204 of FIG. 2.

Process 600 starts at block 602, where a first transport message is received from an initiator device. As discussed herein, the initiator device may be a storage acceleration device similar to the target device, or the initiator device may be another computing device such as a server. After block 602, process 600 proceeds to block 604.

At block 604, a first payload is extracted from the first transport message. In some embodiments, the first payload is extracted using transport acceleration system 406 of target device 204. After block 604, process 600 proceeds to block 606.

At block 606, the first payload is provided to a payload acceleration system. In some embodiments, the first payload is provided to payload acceleration system 412 of target device 204. In some embodiments, before the first payload is provided to the payload acceleration system, the first payload is scheduled using command scheduler 408 of target device 204. In some embodiments, before the first payload is provided to the payload acceleration system, the first payload is translated from a first protocol to a second protocol using protocol translator 410 of target device 204. In one example, the first payload is translated from a fabric storage command (e.g., an NVMe-oF command) to a local storage command (e.g., an NVMe command). In some embodiments, configurable accelerator 420 of payload acceleration system 412 processes the data request to support various storage functions such as RAID, compression, decompression, encryption, decryption, etc. After block 606, process 600 proceeds to block 608.

At block 608, an operation indicated in the first payload is caused to be performed using an appropriate storage device such as a storage device of storage devices 426. In some embodiments, the operation is provided to the storage device using a data buffer. The storage device then returns an indication of a completion status of the operation, which may include additional data. After block 608, process 600 proceeds to block 610.

At block 610, a second payload is created based on a response from the storage device. In some embodiments, the second payload is created using response message generator 416 of payload acceleration system 412. After block 610, process 600 proceeds to block 612.

At block 612, a second transport message is created based on the second payload. In some embodiments, the second transport message is created using transport acceleration system 406. After block 612, process 600 proceeds to block 614.

At block 614, the second transport message is provided to the initiator device. In some embodiments, the second transport message is provided to the initiator device using transport acceleration system 406. After block 614, process 600 ends.

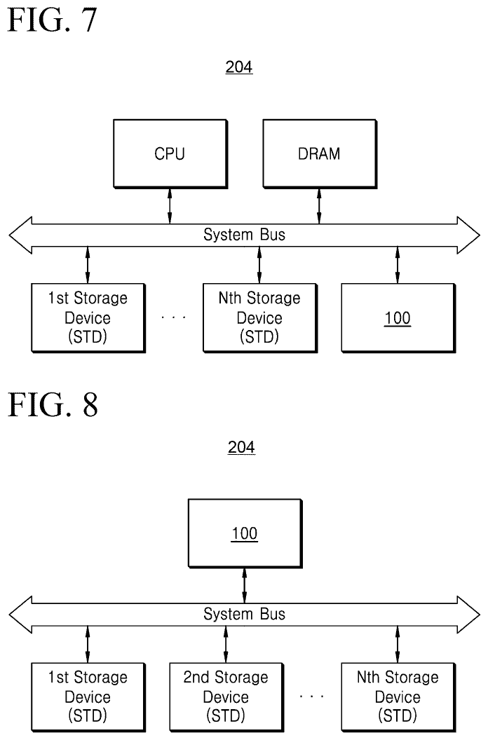

FIG. 7 is a system diagram illustrating interaction between a storage acceleration device and a host device in some embodiments. As shown in FIG. 7, a host device includes components such as CPU, DRAM, storage devices, and storage acceleration device 100. Storage device 100 communicates with components of the host device to accelerate disaggregated storage operations.

FIG. 8 is a system diagram illustrating interaction between a storage acceleration device and a host device in some embodiments. In the example shown in FIG. 8, the host device does not include a CPU or DRAM. The storage devices are arranged in a “just a bunch of flash” (JBoF) configuration that uses storage acceleration device 100 as a PCIe root complex.

FIGS. 11a-11g illustrate example operation of a payload acceleration system processing payloads. In FIGS. 11a-11g, session 0 corresponds to a first user or device and session 4 corresponds to a second user or device.

In FIG. 11a, packet 0 is received for session 4. Packet 0 contains command data of command 1. Accordingly, packet 0 is inserted into a handling table of command handler 414 in a command field corresponding to session 4. As shown in FIG. 11a, packet 0 does not contain all of command 1 of session 4. Accordingly, additional command packets including the remainder of command 1 are to be processed before executing command 1.

In FIG. 11b, packet 1 is received for session 0. Packet 1 contains command data of command 0. Accordingly, packet 0 is inserted into the handling table of command handler 414 in a command field corresponding to session 0. Similar to packet 0 discussed with respect to FIG. 11a, packet 0 does not contain all of command 0 of session 0, so an additional packet including the remainder of command 0 are to be processed before executing command 0.

In FIG. 11c, packet 2 is received. Packet 2 includes the remainder of command 1 of session 4 and 4 kb of data. The data field of the handling table corresponding to session 4 is updated to “4 kb” to reflect the amount of data received in packet 2. Because all of command 1 has been received, message handler 414 provides command 1 to context manager 418, along with the offset and length. In this example, the offset is 0 kb and the length of the data is 4 kb. Context manager 418 extracts identification information from command 1 such as a session identifier “session id” and a command identifier “unique cid”. Based on a base address, the network identifier, the command identifier, and the offset, context manager 418 computes a buffer address “Badd” at which to insert data of packet 2. The base address may be indicated by the buffer address. In some embodiments, a same base address is used for each session. In one example, for each of sessions 0-7, the base address is “0×500000”. In some embodiments, each session is assigned a corresponding base address. Host accelerator 422 provides the data of packet 2 to the data buffer at the buffer address “0×500000”.

In FIG. 11d, packet 3 is received. The payload of packet 3 includes 8 kb of data of session 4. Accordingly, the data field of the handling table corresponding to session 4 is updated to indicate that 8 kb of data has been received. Because 4 kb of data 1 was previously received in packet 2, the offset is 4 kb. Because no additional command is included in packet 3, context manager is to again use command 1 to determine the buffer address. In some embodiments, command 1 is provided to context manager 418, which extracts identification information used to determine the updated buffer address. But because the identification information is the same as previously determined for packet 2 (e.g., the identification information corresponds to command 1 in both examples), in some embodiments, command 1 is not provided to context manager 418. Rather, context manager reuses the previously determined identification information corresponding to command 1.

The updated offset of 4 kb and length of 8 kb is provided to context manager 418. Context manager 418 obtains identification information including the session identifier “session id” and the command identifier “unique cid”. Context manager 418 determines an updated buffer address “Badd” at which to insert the 8 kb of data based on the session identifier, command identifier, and offset. As shown, the updated buffer address is “0×501000”. Host accelerator 422 provides the data of packet 3 to the data buffer at the buffer address “0×501000”. Accordingly, the data of packet 3 is stored in the buffer contiguously with the data of packet 2.

In FIG. 11e, packet 4 is received for session 0. The payload of packet 4 includes the remainder of command 0 and 4 kb of data. Accordingly, the command field of the handling table corresponding to session 0 is updated to include the remainder of command 0, and the data field corresponding to session 0 is updated to indicate that 4 kb of data has been received with an offset of 0 kb. Message handler 414 provides command 0 with the offset of 0 kb and the length of 4 kb to context manager 422. Context manager 418 extracts identification information from command 0 such as a session identifier “session id” and a command identifier “unique cid”. Based on a base address “0×100000”, the network identifier, the command identifier, and the offset, context manager computes a buffer address “0×100000” at which to insert data of packet 4. Host accelerator 422 provides the data of packet 4 to the data buffer at the buffer address “0×100000”.

In FIG. 11f, packet 5 is received for session 4. The payload of packet 5 includes the remainder of data 1 and a portion of command 2. Accordingly, the command field of the handling table corresponding to session 4 is updated to include the portion of command 2, and the data field corresponding to session 4 is updated to indicate that the entire 12 kb of data 1 has been received. The offset and length are provided to context manager 418, along with a flush flag indicating that packet 5 is the last packet associated with command 1.

Context manager 418 continues to use the identification information of command 1 and the offset to calculate the buffer address “0×503000” at which to store the data of packet 5.

In response to receiving the flush flag, context manager 418 provides a submission queue entry (SQE) that indicates a start buffer address of command 1 and an indication of the total data size of command 1 to host accelerator 422. In this example, the start buffer address is “0×500000” and the total data size of 16 kb. Host accelerator 422 provides the SQE to a corresponding submission queue.

In FIG. 11g, packet 6 is received for session 0. Packet 6 includes the last 4 kb of data 0. The data field of the handling table corresponding to session 0 is updated to 0 indicate that the entire data 0 has been received. The offset and length are provided to context manager 418, along with a flush flag indicating that packet 6 is the last packet associated with command 0.

Context manager 418 continues to use the identification information for command 0 and the offset to calculate the buffer address “0×101000” at which to store the data of packet 6.

In response to receiving the flush flag, context manager 418 provides an SQE that indicates a start buffer address of command 0 and an indication of the total data size of command 0 to host accelerator 422. In this example, the start buffer address is “0×100000” and the total data size of 8 kb. Host accelerator 422 provides the SQE to a corresponding submission queue. In some embodiments, the submission queue is the same as the submission queue to which the SQE corresponding to command 1 was submitted. In some embodiments, the submission queue is different from the submission queue to which the SQE corresponding to command 1 was submitted.

Host accelerator 422 submits the SQE corresponding to packet payload 5 where it corresponds to packet payload 6. When multiple SQEs are stored in the submission queue, the submission queue doorbell is updated once and each SQE is transferred in a same operation. This reduces the number of times the submission queue doorbell is delivered to the storage device, reducing traffic to the storage device.

In some embodiments, the data buffer is target device 204. A storage device reads the SQE, performs the operation indicated by the SQE, and provides a completion queue entry (CQE) that indicates a completion status of the operation.

In some embodiments where the SQE includes a write command, the storage device accesses data in the data buffer based on the address included in the SQE. The storage device writes the data to the address and provides a CQE, which contains the command identifier and an indication of whether the operation was successful. In some embodiments, the CQE includes metadata regarding the operation.

In some embodiments where the SQE includes a read command, the storage device reads data based on the address of the SQE. The read data may be included in a CQE, which is provided to a completion queue.

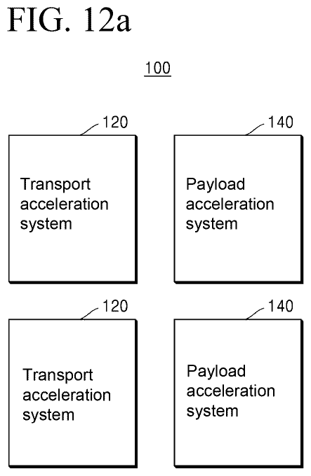

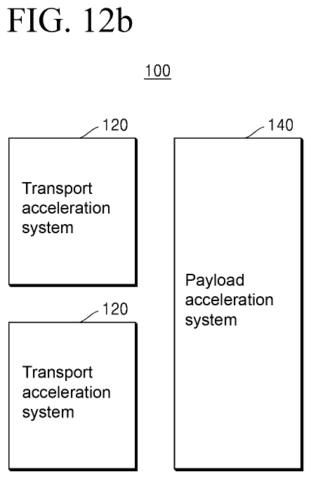

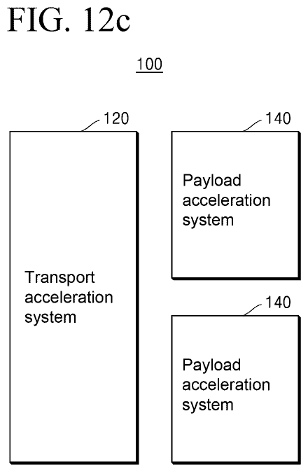

FIGS. 12a-12c are system diagrams illustrate example configurations of transport acceleration systems and payload acceleration systems of a storage acceleration device in some embodiments.

In FIG. 12a, storage acceleration device 100 includes two transport acceleration systems 120 and two payload acceleration systems 140.

In FIG. 12b, storage acceleration device 100 includes two transport acceleration systems 120 and one payload acceleration system 140. In this example, the two transport acceleration systems operate with payload acceleration system 140 to accelerate storage operations.

In FIG. 12c, storage acceleration device 100 includes one transport acceleration system 120 and two payload acceleration systems 140. In this example, the two payload acceleration systems operate with transport acceleration system 120 to accelerate storage operations.

While FIGS. 12a-12c illustrate storage acceleration device configurations involving up to two transport acceleration systems and up to two payload acceleration systems, in various embodiments a storage acceleration device includes any number of transport acceleration systems and payload acceleration systems in any configuration. In one example, a storage acceleration device includes a first transport acceleration system that communicates with three first payload acceleration systems, and a second transport system that communicates with a second payload acceleration system.

The following is a summarization of the claims as originally filed.

A target storage acceleration device may be summarized as including a transport acceleration system configured to extract a first payload from a first transport message; provide the first payload to a payload acceleration system; and the payload acceleration system configured to, based on the first payload including a data request, output data using a buffer address corresponding to the first payload.

The target storage acceleration device may be configured to create, using the transport acceleration system, a second transport message based on the data; and provide the second transport message to an initiator device that provided the first transport message.

The payload acceleration system may include a command handler configured to store command information of the first payload; a context manager that generates a first buffer address based on the command information; and a host accelerator configured to obtain the data using the first buffer address. The command handler may include a handling table that stores information about a command of the first payload. The payload acceleration system may include a configurable accelerator configured to apply a transform to the first payload. The payload acceleration system may include a quality of service (QoS) scheduler system configured to manage access to a storage device based on a scheduling policy. The payload acceleration system may include a quality of service (QoS) scheduler system configured to assign a first I/O queue to a computing device that provided the first transport message.

The payload acceleration system may include a protocol translator configured to translate a command of the first payload from a first protocol to a second protocol. The payload acceleration system may be configured to obtain the data from a storage device using peer-to-peer peripheral component interconnect express (P2P PCIe).

The target storage acceleration device may be a PCIe root complex for a storage device storing the data. The target storage acceleration device may be a PCIe endpoint of a host device. The target storage acceleration device may include an embedded processor configured to implement control plane operations; and a special-purpose processor configured to implement the payload acceleration system and the transport acceleration system. The target storage acceleration device may include a response message generator configured to convert the data into a second transport message; and provide the second transport message to an initiator device that provided the first transport message.

An initiator storage acceleration device may be summarized as including a storage device emulation system configured to present, to a host device, the initiator storage acceleration device as a local storage device; and obtain an operation request from the host device; a payload acceleration system configured to create a payload based on the operation request; and a transport acceleration system configured to encapsulate the payload into a transport message; and provide the transport message to a target device indicated by the operation request.

The target device may be a target storage acceleration device.

The payload acceleration system may be configured to based on determining that the operation request indicates a control plane operation, route the operation request to the host device.

A method performed by an initiator storage acceleration device may be summarized as including obtaining a data request from a host device; converting the data request into a first transport message; providing the first transport message to a target device; receiving, from the target device, a second transport message including data indicated by the data request; converting the second transport message into data in a local storage format; and providing the data in the local storage format to the host device.

The method may include emulating a local storage device of the host device; and obtaining the data request from the host device via a local storage protocol. The method may include processing a control plane operation using an embedded processor of the initiator storage acceleration device. The method may include converting the data request into the first transport message using a first special-purpose processor of the initiator storage acceleration device; and converting the second transport message into the data in the local storage format using a second special-purpose processor of the initiator storage acceleration device.

The preceding description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A target storage acceleration device comprising:
a transport acceleration system configured to:
extract a first payload from a first transport message;
provide the first payload to a payload acceleration system; and
the payload acceleration system configured to:
based on the first payload including a data request, output data using a buffer address corresponding to the first payload.

2. The target storage acceleration device of claim 1, wherein the target storage acceleration device is configured to:
create, using the transport acceleration system, a second transport message based on the data; and
provide the second transport message to an initiator device that provided the first transport message.

3. The target storage acceleration device of claim 1, wherein the payload acceleration system comprises:
a command handler configured to store command information of the first payload;
a context manager that generates a first buffer address based on the command information; and
a host accelerator configured to obtain the data using the first buffer address.

4. The target storage acceleration device of claim 3, wherein the command handler comprises:
a handling table that stores information about a command of the first payload.

5. The target storage acceleration device of claim 1, wherein the payload acceleration system comprises:
a configurable accelerator configured to apply a transform to the first payload.

6. The target storage acceleration device of claim 1, wherein the payload acceleration system comprises:
a quality of service (QoS) scheduler system configured to manage access to a storage device based on a scheduling policy.

7. The target storage acceleration device of claim 1, wherein the payload acceleration system comprises:
a quality of service (QoS) scheduler system configured to assign a first I/O queue to a computing device that provided the first transport message.

8. The target storage acceleration device of claim 1, wherein the payload acceleration system comprises:
a protocol translator configured to:
translate a command of the first payload from a first protocol to a second protocol.

9. The target storage acceleration device of claim 1, wherein the payload acceleration system is configured to:
obtain the data from a storage device using peer-to-peer peripheral component interconnect express (P2P PCIe).

10. The target storage acceleration device of claim 1, wherein the target storage acceleration device is a PCIe root complex for a storage device storing the data.

11. The target storage acceleration device of claim 1, wherein the target storage acceleration device is a PCIe endpoint of a host device.

12. The target storage acceleration device of claim 1, comprising:
an embedded processor configured to implement control plane operations; and
a special-purpose processor configured to implement the payload acceleration system and the transport acceleration system.

13. The target storage acceleration device of claim 1, comprising:
a response message generator configured to:
convert the data into a second transport message; and
provide the second transport message to an initiator device that provided the first transport message.

14. An initiator storage acceleration device comprising:
a storage device emulation system configured to:
present, to a host device, the initiator storage acceleration device as a local storage device; and
obtain an operation request from the host device;
a payload acceleration system configured to:
create a payload based on the operation request; and
a transport acceleration system configured to:
encapsulate the payload into a transport message; and
provide the transport message to a target device indicated by the operation request.

15. The initiator storage acceleration device of claim 14, wherein the target device is a target storage acceleration device.

16. The initiator storage acceleration device of claim 14, wherein the payload acceleration system is configured to:
based on determining that the operation request indicates a control plane operation, route the operation request to the host device.

17. A method performed by an initiator storage acceleration device, the method comprising:
obtaining a data request from a host device;
converting the data request into a first transport message;
providing the first transport message to a target device;
receiving, from the target device, a second transport message including data indicated by the data request;
converting the second transport message into data in a local storage format; and
providing the data in the local storage format to the host device.

18. The method of claim 17, comprising:
emulating a local storage device of the host device; and
obtaining the data request from the host device via a local storage protocol.

19. The method of claim 17, comprising:
processing a control plane operation using an embedded processor of the initiator storage acceleration device.

20. The method of claim 17, comprising:
converting the data request into the first transport message using a first special-purpose processor of the initiator storage acceleration device; and
converting the second transport message into the data in the local storage format using a second special-purpose processor of the initiator storage acceleration device.
